(19) United States
(12) Patent Application Publication
(10) Pub. No.: US 2005/0063099 A1
(43) Pub. Date: Mar. 24, 2005

(54) Data transfer device and head assembly therefor

(75) Inventors: James Anthony West, Bristol (GB); David Nicholas Callaghan, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 10/832,454

(22) Filed: Apr. 27, 2004

(30) Foreign Application Priority Data
Apr. 28, 2003 (GB) 0309554.4

(51) Int. Cl. G11B 15/64

(52) U.S. Cl. 360/261.1

(57) ABSTRACT

A magnetic tape drive includes a head assembly comprising a read and/or write head mounted for movement along at least one guide rail. A rail cleaner cleans at least a portion of the rail. The cleaner moves along the rail with the head assembly.

### FIELD OF INVENTION

This invention relates to improvement in data transfer devices and to an improved head assembly for a data transfer device.

### BACKGROUND ART

Data transfer devices such as magnetic tape drives are widely used for the storage of digital or binary data, and are especially suitable for backing up large volumes of data.

A tape drive is just one example of a data transfer device. It comprises a spool onto which a length of tape from a cassette is wound. The spool is rotated so that the tape is drawn across a face of the tape head. The head reads the data from the tape, or alternatively can be used to write data to the tape.

Data is typically arranged into two or more parallel tracks along the length of the tape. The head correspondingly comprises two or more head elements—one for each track. These head elements must be accurately aligned with the tracks on the tape for successful reading/writing of data.

As well as the number of parallel tracks, the speed at which the tape is drawn past the head determines the rate at which data is accessed. Most drives are designed to draw the tape past the head at high speed. This results in the tape being drawn across the head in an unpredictable manner. The head is supported on a movable carrier which is adapted to move the head from side to side relative to a fixed datum. The head can be moved along the rails to switch between tracks on the tape. Smaller movement can also be made to permit the head to follow the tracks on the tape and allow for some movement from side to side of the tape. A servo track is provided on the tape which the head reads and the information from the servo track is fed to a closed loop servo control system which controls the operation of a motor connected to the carrier.

A problem arises if the head does not move smoothly as may occur if obstacles such as dust or other debris are present. A loss of data can occur in severe cases. As such, attempts have been made to minimise the amount of debris that can get into the assembly.

Similar problems exist with other types of data transfer device which may use magnetic or perhaps another form of storage media. An example is an optical storage device in which information is stored on a disc and is read using an optical read head. Indeed, the invention has application to any data transfer device which includes a movable read head.

According to a first aspect the invention provides a data transfer device which includes a head assembly comprising a read and/or write head adapted to read and/or write information from/to a storage media mounted for movement along at least one guide rail; wherein a rail cleaner is provided for cleaning at least a portion of the rail.

The storage media may comprise an optical or a magnetic storage media or perhaps another type of media. Indeed, the invention has application to any presently available form of data storage media which can be read by a movable read head. In a most advantageous application it is envisaged that the device may comprise a magnetic tape drive with the storage media comprising a removable tape cartridge.

The head assembly may include a carrier which supports the head for movement along the rail.

The rail cleaner may act to clean the rail when the head moves along the guide rail.

Providing a rail cleaner ensures that debris on the rail is removed or at least partially removed or displaced, preventing it from interfering with movement of the carrier along the rail.

The head may be supported upon the rail by one or more bearings. The or each bearing may comprise a roller bearing. Alternatively the carrier may have a sliding engagement with the rail.

Most preferably two rails are provided which are disposed in parallel and the head may move along both rails. This provides a stable support for the head.

The rail or rails may be fixed relative to a housing of the drive. A circuit board may also be fixed relative to the housing and carry electronics for processing output signals from the read head. A flexible circuit board or cable may connect the circuit board to the read head.

The head may be soldered, screwed, bolted, glued or otherwise fixed to the carrier.

The rail cleaner may be supported by the head or a carrier which supports the head. This provides a simple construction.

Alternatively the rail cleaner may comprise a fixed portion which is fixed for movement relative to said rail and a movable portion which is supported by the fixed portion and which is movable relative to the fixed portion into and out of engagement with the head, the movable portion supporting one or more wipers.

The fixed portion may be fixed to a housing of the tape drive.

The movable portion may be releasably secured to the carrier and a retraction mechanism may be provided which is adapted to move the movable portion into and out of engagement with the head. This allows the cleaner to be used to clean the rails only when required. For example, the rail may only be cleaned periodically or wherever an impulse (suggesting the presence of dirt or debris on the rail) is detected.

The fixed portion may comprise a sub-frame and the movable portion may comprise a sled which is supported on the sub-frame by at least one track, the retraction mechanism being arranged to move the sled along the track. An electric motor may be provided which causes the sled to move relative to the track between a first position in which the movable portion engages the carrier/head and a second position in which it is clear of the carrier/head.

The rail cleaning mechanism may include at least one wiper, such as a wiper blade, which is operable to contact the or each rail. In the case of a rail cleaner which has a fixed portion and a movable portion the cleaning blade would, of course, be supported by the movable portion.

The wiper may be fixed to the carrier by a supporting arm. Thus, as the carrier moves, the wiper moves along the rail or rails.

Two wipers may be provided for each rail, one wiper to each side of the head. Thus, as the head moves there will always be one wiper ahead of the head along the rail regardless of the direction in which it is moved. Therefore, one wiper may be provided in front of the head and another at the back.

The wiper blade may be conformed to the shape of the rail. For example, when a curved rail is provided, the wiper blades may also be curved so that they contact a circumference of the rail. They may be deformable and resiliently urged into contact with the rail such that they conform to the shape of the rail.

The wiper blade(s) may be flexible and optionally resilient, and may be of plastic material, or perhaps a thin metal foil. The blade elements may be inclined relative to the rail.

The data transfer device may in a most preferred arrangement comprise a magnetic tape drive adapted to read and or write information from or onto a magnetic tape.

According to a second aspect the invention provides a head assembly for a data transfer device comprising a head mounted for movement along at least one guide rail and a rail cleaner which is operable to clean debris from the guide rail.

At least a portion of the rail cleaner may be fixed for movement relative to the head carrier or to the guide rail, in each case a portion of the cleaning assembly being displaceable relative to the guide rail to clean the rail.

The head may be supported on the guide rail by at least one bearing.

According to a third aspect the invention provides a transfer device which includes a head assembly comprising a read and/or write means adapted to read and/or write information from/to a storage means, the head assembly being mounted for movement along at least one guide rail; wherein a rail cleaning means is provided for cleaning at least a portion of the rail.

The read and or write means may comprise data transfer elements, such as magneto resistive elements. They may, for example comprise the data transfer elements of a tape drive or a disk drive. The storage means may therefore comprise a tape such as a magnetic tape or a disk.

### BRIEF DESCRIPTION OF THE DRAWING

There will now be described, by way of example only, two embodiments of the present invention with reference to the accompanying drawings of which:

FIG. 1 is a perspective view of an embodiment of a tape drive assembly in accordance with the present invention with the lid of the assembly removed to show the internal components of the assembly;

FIG. 2 is a perspective view of the head assembly used in the tape drive shown in FIG. 1;

FIG. 3(a) is one schematic view and (b) an alternative view of a first embodiment head, head carrier, guide rails and rail cleaner which forms a part of a first embodiment of a tape drive assembly;

FIG. 4(a) is one schematic view and (b) an alternative view of a second embodiment of a head, carrier, guide rails and rail cleaner which forms a part of a second embodiment of a tape drive assembly; and

FIG. 5(a) and (b) are views corresponding to those of FIGS. 4(a) and 4(b) with the cleaning mechanism in a second position.

### DETAILED DESCRIPTION OF THE DRAWINGS

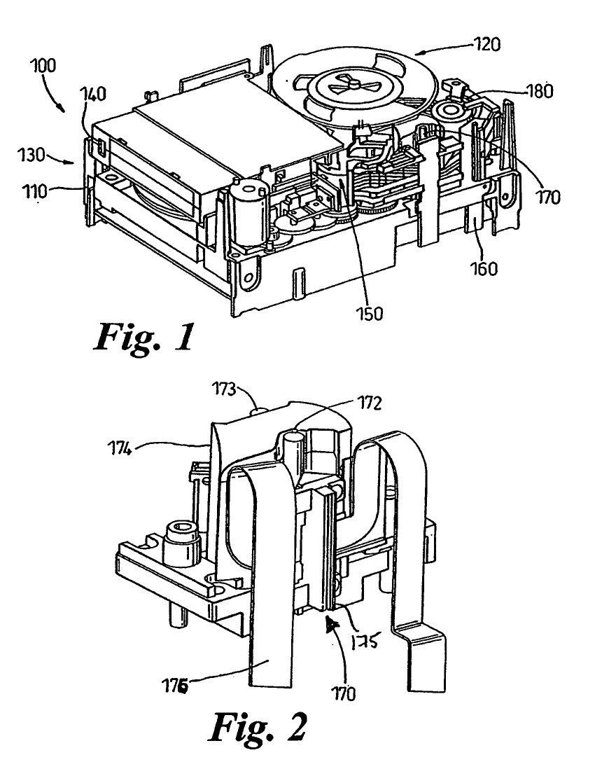

As shown in FIG. 1 of the accompanying drawings, a data transfer device comprising a magnetic tape drive mechanism 100 comprises a chassis 110 which supports an electric motor (not shown) connected to a spool or take up reel 120. The chassis forms part of a housing which has an opening 130 into which a tape cartridge 140 can be inserted. A leader grabber 150 is supported by the chassis 110 adjacent the tape cartridge 140 when it is inserted for grabbing the leader of the tape in the cartridge. The chassis 110 also supports a threading leader 160 which takes the tape leader from the leader grabber 150 and feeds it past a head assembly 170. A further guide roller 180 provided next to the head grabs the leader and feeds it to the take-up reel. A planar printed circuit board running along the length of the chassis provides control signals and power feeds to the motor, the grabbers and the head assembly.

In use, the take up reel 120 is spun by the motor to rapidly draw the tape past the head assembly 170. The tape carries information which is read by a read head as the tape passes.

The head assembly 170, which can write information to the tape as well as read information from it, is shown in more detail in FIG. 2 of the accompanying drawings. It comprises a read head 175 in the form of a plurality of magneto-resistive read head elements provided in a block on a common substrate. The head assembly 170 includes a head carrier 171 which is supports the head 170 relative to the chassis for movement along two guide rails 172,173 and co-operates with a voice coil 174 to define the moving part of a linear motor. Application of a drive current to the voice coil 174 causes the carrier 171 and hence the head 175 to move along the guide rails 172,173 permitting the head assembly to follow tracks laid down on the tape and also to move by small amounts to allow for side to side movement of the tape. A servo control circuit provides the drive current for the motor in a closed loop configuration using measurements of the head position. A flexible circuit such as a ribbon cable 175 connects the head to the main circuit board of the tape assembly.

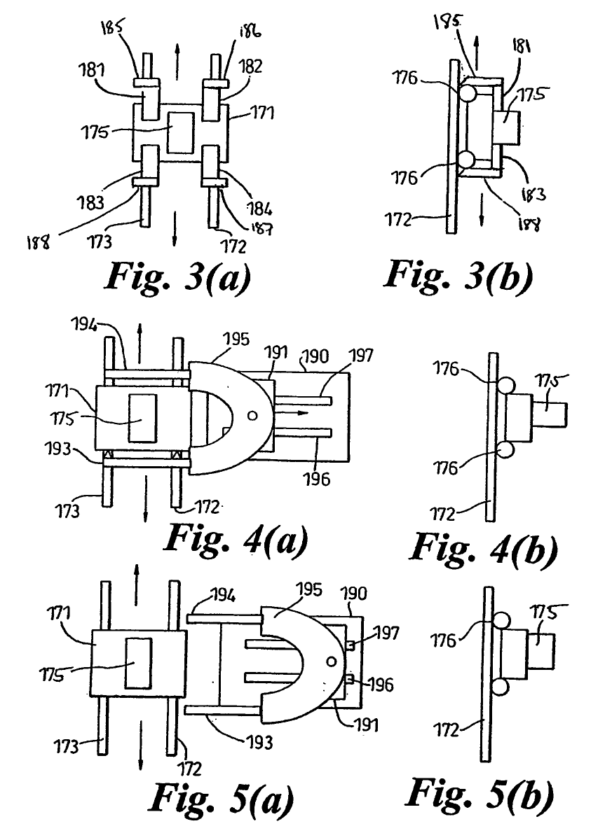

As can be seen in FIGS. 3 to 5, the carrier 171 is supported on each guide rail by a respective pair of spaced bearings 176, with one bearing provided at each end of the carrier 171. One of the pairs of bearings 176 is mounted to a spring arm (not shown) that provides a preload for the bearings. This bearing/guide rail system provides a low friction means for precisely positioning the head relative to the tape.

A rail cleaner is provided which clears dust and other debris from the rails. It has been found by the applicant that an event where one or more of the bearings rolls over any dust or debris can interfere with the correct operation of the servo-loop and that it would be desirable to prevent such an event occurring. Two different embodiments of tape assembly cleaning mechanisms are illustrated in FIGS. 3(a) and (b), 4(a) and (b) and 5(a) and (b) of the accompanying drawings.

In a first embodiment illustrated from the side in FIG. 3(a) and from above in FIG. 3(b) the rail cleaner is fixed for movement relative to the head and moves relative to the guide rails as the head moves. It comprises four arms 181, 182, 183 and 184 which project from the head assembly. The arms are grouped into two pairs, with one pair projecting outwards from one end of the head carrier 171 and the other pair projecting outwards from the other end of the carrier 171. Each arm, 181,182,183 and 184 carries a wiper blade 185,186,187,188 which is profiled to match the circumference of a respective guide rail 172/173. The arms 181,182,183,184 press the respective wiper blades 185,186,187,188 lightly onto the guide rails 172,173 in front of the bearings and after the bearings (regardless of the direction of travel of the carried along the rails) and therefore serve to sweep debris such as dust from the guide rail as the carrier 171 is moved.

An alternative embodiment is illustrated in FIGS. 4(a), (b) and FIGS. 5(a) and (b) of the accompanying drawings. In this embodiment the cleaning mechanism is not permanently attached to the head carrier 171 but instead is supported by the chassis. It comprises a sub-frame 190 which is fixed relative to the chassis and a sled 191 which carries two pairs of blades 193,194. The blades 193,194 are pivotally fixed to the sled by a wishbone shaped support 195. The sled 191 is constrained to move along tracks 196,197 defined by the sub-frame which are substantially orthogonal to the guide rails. The sled can move along these tracks between a first position shown in FIG. 4(a) in which the wishbone 195 is spaced from the head carrier 171 and a second position shown in FIG. 4(b) in which it is in contact with the carrier 171.

When in the first position of FIG. 4(a) the blades 193,194 contact the guide rails 172,173 and sweep along the guide rails under a force provided by the carrier 171. The blades 193,194 are thus swept along the rails to clean them. In the second position of FIG. 4(b) the blades 193,194 are held clear of the rails and no cleaning occurs.

In the example the wishbone support 195 holds the pairs of blades 193,194 a sufficient distance apart to accommodate the head carrier 171 therebetween. Care must be taken to ensure that the sled 191 only moves from the second position to the first position when the head carrier 171 is in the correct location or damage may occur. This can be achieved using a motor (not shown) to drive the sled, perhaps through a rack and pinion, and providing an interlock between the motor for the sled 191 and the motor for the head carrier 171. It will be apparent that the sled does not need to be moved with any thing like the precision needed to move the head carrier, allowing a simpler system to be used to provide the movement.

It will also be appreciated that the blades 193,194 should be free to move with the carrier. This can be achieved by ensuring that the supporting wishbone 195 is free to move relative to the sled, for example by pivoting about a single point of contact 196 with the sled 191.

In a more complex arrangement (not shown) a mechanism may be provided for engaging the blades with the head carrier and then removing them when not needed. For example, the wishbone may be connected to the sled by a releasable connection such as a solenoid operated catch.

It is envisaged that the second embodiment, whilst requiring more components, may be preferred in some instances as it reduces the wear on the guide rails. An output signal derived from the behaviour of the servo-loop may be used to control when the rails are to be cleaned, for example whenever an error which may have been caused by debris is identified. Alternatively, cleaning may be performed at set times, such as a set time interval or whenever a tape is inserted or removed, or whenever the assembly is powered up or down.

The blades may be resilient strips of plastic as shown in FIG. 6(a). The resilience allows the blades to conform to the shape of the guide rail. Alternatively they may comprise shaped elements of metal foil which have the same form as the guide rails.

1. A data transfer device comprising at least one of a read head adapted to read information from a storage medium and a write head adapted to write information to a storage medium, said at least one head being mounted for movement along at least one guide rail; and a rail cleaner for cleaning at least a portion of said rail, said rail cleaner being arranged to move with said head along said guide rail to clean said guide rail.

2. A data transfer device according to claim 1 wherein said rail cleaner includes at least one wiper for contacting the rail.

3. A data transfer device according to claim 2 wherein said wiper comprises a wiper blade.

4. A data transfer device according to claim 2 wherein the wiper is fixed for movement relative to said at least one head by a supporting arm.

5. A data transfer device according to claim 2 wherein said at least one wiper conforms to the shape of said rail.

6. A data transfer device according to claim 2 wherein said rail cleaner includes at least two blades, one of said blades being on each side of said head.

7. A data transfer device according to claim 6 wherein the at least one wiper is deformable and for resilient urging into contact with said rail for causing the wiper to conform to the shape of the rail.

8. A data transfer device according to claim 1 wherein said head is supported on said rail by one or more bearings.

9. A data transfer device claim 1 wherein two of said rails are disposed in parallel and said head is supported by both rails.

10. A data transfer device according to claim 1 wherein said rail cleaner comprises a fixed portion fixed for movement relative to said rail and a movable portion supported by said fixed portion, the movable portion being movable relative to said fixed portion so said movable portion is moveable into and out of engagement with said head, said movable portion supporting one or more wipers.

11. A data transfer device according to claim 10 further including a retraction mechanism adapted to move said movable portion into and out of engagement with said head.

12. A data transfer device according to claim 11 wherein said fixed portion comprises a sub-frame and said movable portion comprises a sled supported on said fixed portion by at least one track, said retraction mechanism being arranged to move said sled along said track.

13. A data transfer device according to claim 12 wherein said retraction mechanism includes an electric motor for moving said sled along said track.

14. A head assembly for a data transfer device comprising a head mounted for movement along at least one guide rail and a rail cleaner for cleaning debris from the guide rail, said rail cleaner being arranged to move along said rail with said head assembly.

15. A head assembly according to claim 14 wherein said cleaner is fixed for movement relative to said head.

16. A head assembly according to claim 14 wherein said head carrier is supported on said guide rail by at least one bearing.

17. A head assembly according to claim 14 wherein said rail cleaner includes at least one wiper.

18. A magnetic tape drive device comprising a head assembly including at least one of a read means adapted to read information from a storage means and a write means adapted to write information to a storage means, said head assembly being mounted for movement along at least one guide rail; and a rail cleaning means for cleaning at least a portion of the rail.

19. A data transfer device comprising a head assembly including at least one of a read head adapted to read information from a storage media and a write head adapted to write information to a storage media, said at least one head being mounted for movement along at least one guide rail, and a rail cleaner having a fixed portion fixed for movement relative to said rail and a movable portion supported by said fixed portion and movable relative to said fixed portion, said movable portion being arranged to be moved into and out of engagement with said head, said movable portion supporting one or more wipers.

20. A magnetic tape drive head assembly comprising a head mounted for movement along at least one guide rail and a rail cleaner for cleaning debris from the guide rail, said rail cleaner being arranged to move along said rail with said head assembly.
